(19) United States
(12) Patent Application Publication
(10) Pub. No.: US 2025/0319811 A1
(43) Pub. Date: Oct. 16, 2025

(54) STEERING COLUMN SWITCH FOR A MOTOR VEHICLE

(71) Applicant: KOSTAL Automobil Elektrik GmbH & Co. KG, Lüdenscheid (DE)

(72) Inventors: Martin DEITMERG, Lüdenscheid (DE); Alexander TRINN, Lüdenscheid (DE)

(73) Assignee: KOSTAL Automobil Elektrik GmbH & Co. KG, Lüdenscheid (DE)

(21) Appl. No.: 19/253,181

(22) Filed: Jun. 27, 2025

Related U.S. Application Data
(63) Continuation of application No. PCT/EP2024/053668, filed on Feb. 14, 2024.

(30) Foreign Application Priority Data
Feb. 17, 2023 (DE) 102023103973.3

(51) Int. Cl. B60Q 1/14

(52) U.S. Cl. CPC B60Q 1/1469

(57) ABSTRACT

A steering column switch for a motor vehicle includes a steering column switch housing, a switch lever, a switch gate, a spring-loaded locking pin, a locking pin sleeve, and a support part. The switch lever is pivotably mounted on the housing. The switch lever is a one-armed lever having an actuating lever arm that is pivotable against a restoring force from a stable neutral position into functional positions. A switch function is enabled upon reaching each functional position. The switch gate and the spring-loaded locking pin are inside the actuating lever arm. The spring-loaded locking pin is guided in the switch gate and brings about the restoring force. The locking pin sleeve is fixedly connected to the actuating lever arm. The support part is affixed to the housing. The spring-loaded locking pin is accommodated in the locking pin sleeve and the switch gate is fixedly connected to the support part.

### CROSS-REFERENCE TO RELATED APPLICATIONS

This application is a continuation of International Application No. PCT/EP2024/053668, published in German, with an international filing date of Feb. 14, 2024, which claims priority to DE 10 2023 103 973.3, filed Feb. 17, 2023, the disclosures of which are hereby incorporated in their entirety by reference herein.

### TECHNICAL FIELD

The present invention relates to a steering column switch for a motor vehicle, the steering column switch having at least one switch lever that is pivotably mounted on a steering column switch housing, the switch lever being designed as a one-armed lever having an actuating lever arm, the actuating lever arm being pivotable against a restoring force from a stable neutral position into at least one functional position, wherein a respective associated function is switched upon the actuating lever arm reaching each functional position, the steering column switch further having a switch gate and a spring-loaded locking pin that are situated inside the actuating lever arm, the locking pin being guided in the switch gate, the restoring force being effected or brought about by the locking pin.

### BACKGROUND

Various functional requirements are imposed on steering column switches of this type. Thus, for example, wiper functions, blinker functions, headlight flashers, or high beam changeover are/is switched on and off via a plurality of pivoting movements of the switch lever in different directions.

There are steering column switches that are brought into their functional positions via touching or latching. After leaving a particular functional position, the switch lever automatically returns to its neutral position. The neutral position and the functional positions are defined by the interaction of a spring-loaded locking pin with an associated switch gate, which exerts a restoring force on the switch lever.

Thus, for example, a steering column switch for motor vehicles corresponding to the steering column switch described above in the Technical Field has become known from DE 197 44 088 A1. In this steering column switch, an actuation knob of the switch is connected to an immovable lever section via a cardan joint. The switch gate is fixedly connected to an actuation knob or operating button.

In the marketplace, there is an increasing demand to significantly reduce the installation space required for the so-called sub-switches, i.e., the components of the switch situated inside the steering column switch housing, to use the space thus gained for other functions. Such other functions include a driver observation camera or further sensors. At the same time, however, increasingly smaller actuation angles are being required for the lever movement. In previous steering column switches, good haptics have been achieved, among other things, by the locking pin traveling a sufficiently great distance in the switch gate when the lever is actuated. If the actuation angles are decreased, for the same distance of the switch gate from the lever pivot, this distance is reduced and the haptics become noticeably poorer (i.e., if the actuation angle is reduced, this travel is reduced at the same distance between the switch gate and the lever pivot point and the haptics become noticeably worse). However, an increase in this distance would require more installation space inside the steering column switch housing, which is not available.

### SUMMARY

An object of the present invention is a steering column switch having the advantage of solving the above-noted installation space problems.

In embodiments of the present invention, a steering column switch, such as for a motor vehicle, includes a steering column switch housing, at least one switch lever, a switch gate, a spring-loaded locking pin, a locking pin sleeve, and a support part. The switch lever is a one-armed lever having an actuating lever arm and is pivotably mounted on the steering column switch housing. The actuating lever arm is pivotable against a restoring force from a stable neutral position into at least one functional position. A respective associated function is switched or enabled upon the actuating lever arm reaching each functional position. The switch gate and the locking pin are situated inside the actuating lever arm with the locking pin being guided in the switch gate. The restoring force is effected or brought about by the locking pin. The locking pin sleeve is fixedly connected to the actuating lever arm and the support part is affixed to the steering column switch housing. The locking pin is accommodated in the locking pin sleeve, and the switch gate is fixedly connected to the support part.

A steering column switch in accordance with embodiments of the present invention achieves the object in that the spring-loaded locking pin is accommodated in a locking pin sleeve that is fixedly connected to the actuating lever arm, and the switch gate is fixedly connected to a support part that is affixed to the steering column switch housing.

Pivotability of the steering column switch about two mutually perpendicular axes is made possible by the fact that the bearing of the switch lever on the steering column switch housing takes place by means of a cardan joint.

### BRIEF DESCRIPTION OF THE DRAWINGS

The present invention is explained in greater detail below with reference to the exemplary embodiments illustrated in the drawings. The figures show the following (in each case in an assembled state and in an exploded illustration):

FIG. 1 illustrates a first embodiment of a steering column switch according to the present invention, with a locking pin sleeve that is fixedly connected to the actuating lever arm; and

FIG. 2 illustrates a second embodiment of a steering column switch according to the present invention, with a locking pin sleeve that is fixedly connected to the actuating lever arm.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of components. Therefore, specific structural and functional details disclosed herein are not to be interpreted as limiting, but merely as a representative basis for teaching one skilled in the art to variously employ the present invention.

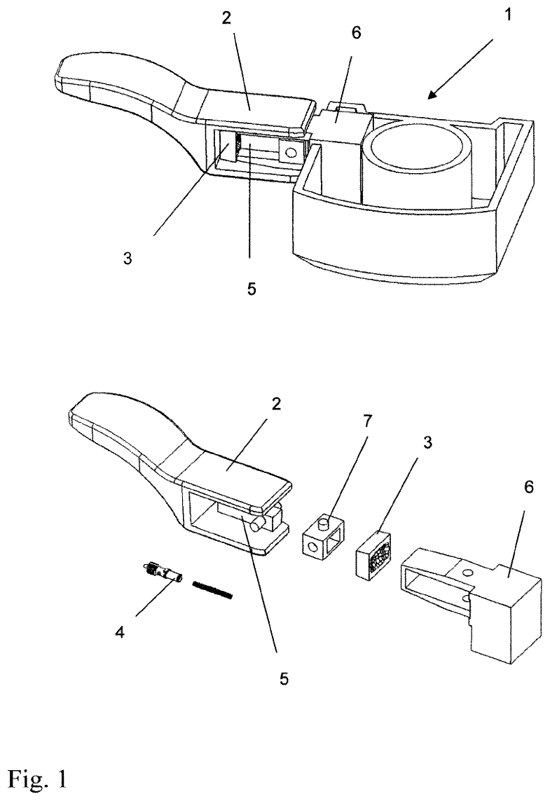

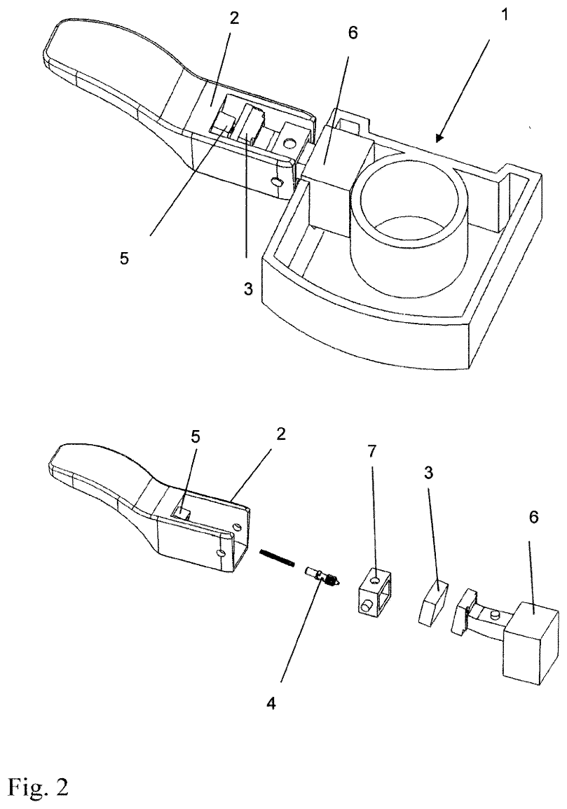

Referring now to FIGS. 1 and 2, a steering column switch for a motor vehicle in accordance with first and second embodiments of the present invention, respectively, are shown. In each of FIGS. 1 and 2, an assembled state of the steering column switch and an exploded view of the steering column switch are shown.

As is apparent from FIGS. 1 and 2, in all illustrated embodiments, the steering column switch includes a steering column switch housing 1, at least one switch lever, a switch gate 3, a spring-loaded locking pin 4, a locking pin sleeve 5, and a support part 6. The switch lever is pivotably supported on steering column switch housing 1. The switch lever is designed as a one-armed lever whose single arm forms an actuating lever arm 2 of the switch lever. Switch gate 3 and locking pin 4 are situated inside actuating lever arm 2 with the locking pin being guided in switch gate 3.

Actuating lever arm 2 is supported to be pivotable about two mutually perpendicular axes by means of a cardan joint 7. Starting from a stable neutral position, actuating lever arm 2 may thus be brought, against a restoring force, into multiple functional positions. Upon reaching each functional position, a respective associated function is electrically switched. The restoring force for actuating lever arm 2 is brought about by a spring-loaded locking pin 4 that is guided in a switch gate 3. The individual functional positions may in each case have a latching or touch-activated design, which is implemented in a known manner via an appropriate design of switch gate 3.

Locking pin sleeve 5 is fixedly connected to actuating lever arm 2. Support part 6 is affixed to steering column switch housing 1. Locking pin 4 is accommodated by locking pin sleeve 5. Switch gate 3 is fixedly connected to support part 6.

These two embodiments differ in that in the design according to FIG. 1, the tip of locking pin 4 points in the direction of the distal end of actuating lever arm 2, whereas in the design according to FIG. 2, the tip of locking pin 4 points in the direction of support part 6. This shows that freedom of design depending on the other requirements, such as the often-specified external shape of actuating lever arm 2, is provided.

Switching elements which provide contacting or operate by sensor, for example which operate optically or magnetically, are present for electrically switching the functions associated in each case with the functional positions of the switch lever. These switching elements are not illustrated in the drawings but may likewise be situated inside actuating lever arm 2, so that for these as well, additional installation space inside steering column switch housing 1 is not necessary.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A steering column switch for a motor vehicle, comprising:
a steering column switch housing;
a switch lever pivotably mounted on the steering column switch housing, the switch lever being a one-armed lever having an actuating lever arm, the actuating lever arm being pivotable against a restoring force from a stable neutral position into at least one functional position, wherein a respective associated function is enabled upon the actuating lever arm reaching each functional position;
a switch gate;
a spring-loaded locking pin;
the switch gate and the spring-loaded locking pin being situated inside the actuating lever arm;
the spring-loaded locking pin being guided in the switch gate and bringing about the restoring force;
a locking pin sleeve fixedly connected to the actuating lever arm;
a support part that is affixed to the steering column switch housing;
the spring-loaded locking pin being accommodated in the locking pin sleeve and the switch gate being fixedly connected to the support part.

2. The steering column switch according to claim 1 wherein:
the switch lever is pivotably mounted on the steering column switch housing by a cardan joint which allows the switch lever to pivot about two mutually perpendicular axes.

3. The steering column switch according to claim 1 wherein:
switching elements which provide contacting or operate by sensor are situated inside the actuating lever arm for electrically switching the functions associated with the functional positions.
